(19) United States
(12) Patent Application Publication
(10) Pub. No.: US 2023/0305203 A1
(43) Pub. Date: Sep. 28, 2023

(54) LOW COST FABRICATION OF OPTICAL DEVICE USING DISCRETE GRATING MODULE ASSEMBLY

(71) Applicant: Applied Materials, Inc., Santa Clara, CA (US)

(72) Inventors: Hao TANG, San Jose, CA (US); Kang LUO, San Jose, CA (US); Yongan XU, Santa Clara, CA (US); Andrew CEBALLOS, Palo Alto, CA (US); Rutger MEYER TIMMERMAN THIJSSEN, Sunnyvale, CA (US)

(21) Appl. No.: 18/183,273

(22) Filed: Mar. 14, 2023

Related U.S. Application Data
(60) Provisional application No. 63/269,928, filed on Mar. 25, 2022.

(51) Int. Cl. G02B 5/18; G02B 6/02; G02B 6/42; G02B 6/34

(52) U.S. Cl. CPC G02B 5/1847; G02B 6/02038; G02B 6/4257; G02B 6/34; G02B 2207/101

(57) ABSTRACT

Embodiments of the present disclosure relate to optical device fabrication using methods of discrete grating assembly and optical interconnection. Discrete gratings corresponding to one of an input coupling grating, an intermediate grating, or an output coupling grating of an optical device are formed on separated donor substrates. The donor substrates are diced into individual gratings and adhered to an optical device substrate. An inkjet material is disposed between the gratings to optically interconnect the portions of the optical device.

### CROSS-REFERENCE TO RELATED APPLICATIONS

This Application claims the benefit of and priority to U.S. Provisional Application 63/269,928 filed on Mar. 25, 2022, which is herein incorporated by reference in its entirety.

### BACKGROUND

### Field

Embodiments of the present disclosure generally relate to optical device fabrication. Specifically, embodiments of the present disclosure relate to optical device fabrication using methods of discrete grating assembly and optical interconnection.

### Description of the Related Art

Virtual reality (VR) is generally considered to be a computer generated simulated environment in which a user has an apparent physical presence. A VR experience can be generated in 3D and viewed with a head-mounted display (HMD), such as glasses or other wearable display devices that have near-eye display panels as lenses to display a VR environment that replaces an actual environment.

Augmented reality (AR), however, enables an experience in which a user can still see through the display lenses of the glasses or other HMD device to view the surrounding environment, yet also see images of virtual objects that are generated for display and appear as part of the environment. AR can include any type of input, such as audio and haptic inputs, as well as virtual images, graphics, and video that enhances or augments the environment that the user experiences. In order to achieve an AR experience, a virtual image is overlaid on an ambient environment, with the overlaying performed by optical devices.

Multiple optical devices are fabricated on a substrate and then diced prior to use on VR and AR devices. As a result, the substrate can only retain a minimal number of optical devices, while much of the surface area of the substrate is unused. Accordingly, there is a need for a method of optical device fabrication that increases the number of optical devices that may be fabricated.

### SUMMARY

In one embodiment, an optical device is provided. The optical device includes an optical device substrate, a portion of a first donor substrate disposed on an upper surface of the optical device substrate and a first grating disposed on the portion of the first donor substrate. The first grating includes a first plurality of optical device structures. The optical device further includes a portion of a second donor substrate disposed on the upper surface of the optical device substrate and a second grating disposed on the portion of the second donor substrate. The second grating includes a second plurality of optical device structures and an inkjet material disposed between the first grating and the second grating. The inkjet material includes an inkjet height planar with or greater than a height of the first plurality of optical device structures and the second plurality of optical device structures.

In another embodiment, an optical device is provided. The optical device includes an optical device substrate having a first refractive index, and a portion of a first donor substrate disposed on an upper surface of the optical device substrate. The first donor substrate has a second refractive index. The optical device further includes a first grating disposed on the portion of the first donor substrate. The first grating includes a first plurality of optical device structures. The optical device further includes a portion of a second donor substrate disposed on the upper surface of the optical device substrate. The portion of the second donor substrate includes a third refractive index. The optical device further includes a second grating disposed on the portion of the second donor substrate, the second grating including a second plurality of optical device structures. The optical device further includes an inkjet material disposed between the first grating and the second grating. The inkjet material has an inkjet refractive index, with the inkjet refractive index, the first refractive index, the second refractive index, and the third refractive index being substantially equal.

In yet another embodiment, a method of forming an optical device is provided. The method includes forming input coupling gratings on a first donor substrate, forming output coupling gratings on a second donor substrate, and trimming each of the first donor substrate and the second donor substrate to a donor substrate height. The method further includes dicing each input coupling grating and each output coupling grating into a portion of the first donor substrate and a portion of the second donor substrate, adhering the portion of the first donor substrate and the portion of the second donor substrate to an upper surface of an optical device substrate, and disposing an inkjet material between the input coupling grating and the output coupling grating on the optical device substrate.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a schematic, top view of an optical device according to embodiments described herein.

FIGS. 2A-2C are schematic, top views of a donor substrate according to embodiments described herein.

FIG. 3 is a flow diagram of a method of forming the optical device as shown in FIGS. 4A-4F according to embodiments described herein.

FIGS. 4A-4F are schematic, side views of the formation of the optical device during the method according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to optical device fabrication. Specifically, embodiments of the present disclosure relate to optical device fabrication using methods of discrete grating assembly and optical interconnection.

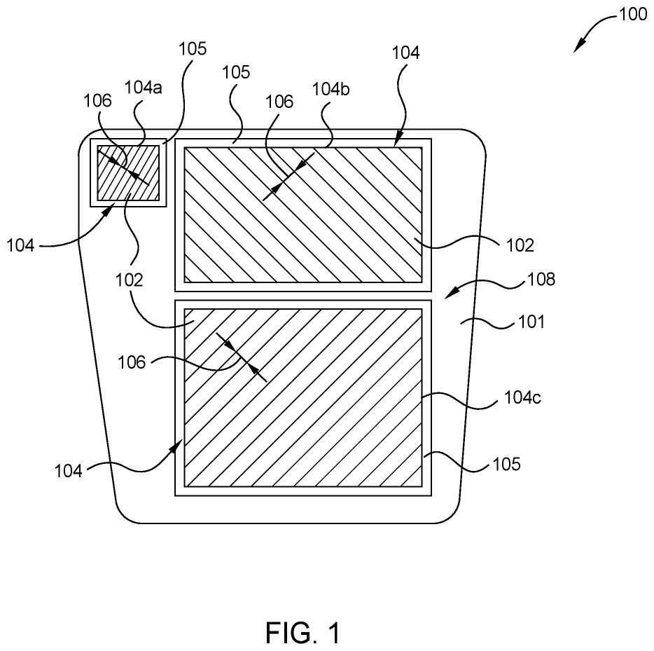

FIG. 1 is a schematic, top view of an optical device 100. It is to be understood that the optical device 100 described below is an exemplary optical device. In one embodiment, which can be combined with other embodiments described herein, the optical device 100 is a waveguide combiner, such as an augmented reality waveguide combiner. The optical device 100 may additionally be an optical device utilized for optical sensing (e.g., eye tracking capabilities). In another embodiment, which can be combined with other embodiments described herein, the optical device 100 is a flat optical device, such as metasurface.

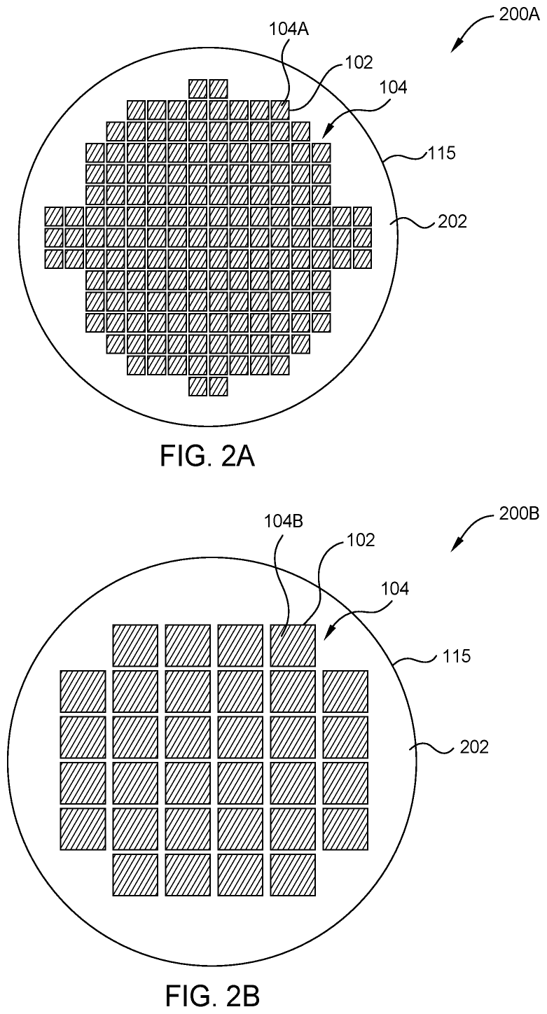

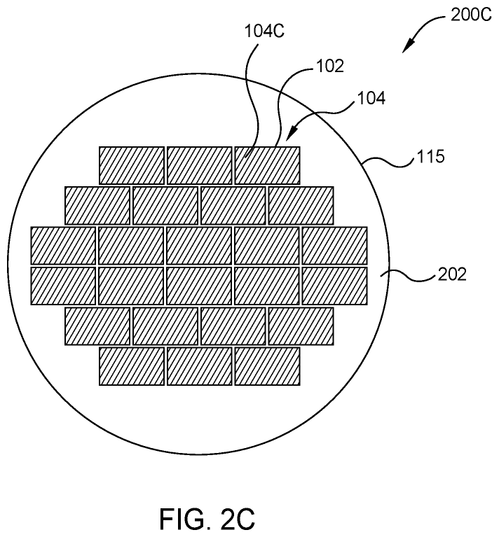

The optical device 100 includes a plurality of optical device structures 102. The optical device structures 102 are disposed on portions 105 of a donor substrate 115 (shown in FIG. 2). The device structures 102 may be nanostructures having sub-micron dimensions, e.g., nano-sized dimensions. For example, a critical dimension 106 of the optical device structures 102 has sub-micron dimensions. In one example, the critical dimension 106 is less than 2 micrometers (μm). In another example, the critical dimensions 106 are about 100 nanometers (nm) to about 1000 nm.

In one embodiment, which can be combined with other embodiments described herein, regions of the device structures 102 correspond to one or more gratings 104, such as a first grating 104A, a second grating 104B, and a third grating 104C. The first grating 104A corresponds to an input coupling grating. The second grating 104B corresponds to an intermediate grating. The third grating 104C corresponds to an output coupling grating. Each of the gratings 104 is disposed on the respective portions 105 of the donor substrate 115 (shown in FIG. 2). Each portion 105 is disposed on an upper surface 103 of the optical device substrate 101.

In some embodiments, which can be combined with other embodiments described herein, the cross-sections of the optical device structures 102 have different shaped cross-sections. In other embodiments, which can be combined with other embodiments described herein, the cross-sections of the optical device structures 102 of the optical device 100 have cross-sections with substantially the same shape. In some embodiments, which can be combined with other embodiments described herein, at least one of the critical dimensions 106 of an optical device structure 102 may be different from the other critical dimensions 106 of the optical device structures 102. In other embodiments, which can be combined with other embodiments described herein, the critical dimensions 106 of the optical device structure 102 are the same.

In one embodiment, which may be combined with other embodiments described herein, the structure material of the optical device structures 102 includes non-conductive materials, such as dielectric materials. The dielectric materials may include amorphous, polycrystalline, or crystalline materials. Examples of the dielectric materials include, but are not limited to, silicon-containing materials, such as Si, silicon nitride (Si₃N₄), silicon oxynitride, silicon carbide (SiC), silicon carbon nitride (SiCN), silicon dioxide, fused silica, or quartz. The silicon may be crystalline silicon, polycrystalline silicon, or amorphous silicon (a-Si). In another embodiment, which may be combined with other embodiments described herein, the structure material of the optical device structures 102 includes, but is not limited to, titanium dioxide (TiO₂), zinc oxide (ZnO), tin dioxide (SnO₂), aluminum-doped zinc oxide (AZO), fluorine-doped tin oxide (FTO), cadmium stannate (Cd₂SnO₄), cadmium stannate (tin oxide) (CTO), zinc stannate (SnZnO₃), tantalum oxide (Ta₂O₅), vanadium (IV) oxide (VOₓ), or niobium oxide (Nb₂O₅) containing materials. In yet another embodiment, which can be combined with other embodiments described herein, the material of the optical device structures 102 includes nanoimprint resist materials. Examples of nanoimprint resist materials include, but are not limited to, at least one of spin on glass (SOG), flowable SOG, organic, inorganic, and hybrid (organic and inorganic) nanoimprintable materials that may contain at least one of silicon oxycarbide (SiOC), TiO₂, silicon dioxide (SiO₂), vanadium (IV) oxide (VOₓ), aluminum oxide (Al₂O₃), indium tin oxide (ITO), ZnO, tantalum oxide (Ta₂O₅), silicon nitride (Si₃N₄), titanium nitride (TiN), zirconium dioxide (ZrO₂) containing materials, or combinations thereof.

The optical device substrate 101 and the donor substrate 115 may be formed from materials including, but not limited to, silicon (Si), silicon dioxide (SiO₂), fused silica, quartz, silicon carbide (SiC), germanium (Ge), silicon germanium (SiGe), indium phosphide (InP), gallium arsenide (GaAs), diamond, gallium nitride (GaN), gallium oxide (Ga₂O₃), or sapphire containing materials. In another embodiment, which can be combined with other embodiments described herein, the optical device substrate 101 and the donor substrate 115 include high refractive index glasses, consisting of one or more of: silicon dioxide (SiO₂), boron oxide (B₂O₃), titanium oxide (TiO₂), zirconium dioxide (ZrO₂), tantalum oxide (Ta₂O₅), niobium oxide (Nb₂O₅), lanthanum oxide (La₂O₃), bismuth oxide (Bi₂O₃), zinc oxide (ZnO), lead oxide (PbO), lithium oxide (Li₂O), sodium oxide (Na₂O), potassium oxide (K₂O), magnesium oxide (MgO), calcium oxide (CaO), strontium oxide (SrO), aluminum oxide (Al₂O₃) and gallium oxide (Ga₂O₃). The material of the optical device substrate 101 and the donor substrate 115 may be different. The optical device substrate 101 has a first refractive index of about 1.6 to about 3.0. The donor substrate 115 has a second refractive index of about 1.6 to about 3.0.

In some embodiments, an inkjet material 108 is disposed between the plurality of gratings 104. The inkjet material 108 is a flowable material that can be deposited onto selective areas on the optical device substrate 101 and the donor substrate 115 using inkjet printing. The inkjet material 108 may be further crosslinked or cured after printing to yield a solidified film. The inkjet material 108 is tuned to have an inkjet refractive index close or identical to a refractive index of the optical device structures 102. In one embodiment, which can be combined with other embodiments described herein, the ink to yield the inkjet material 108 is a colloidal dispersion of nanoparticles. For example, the nanoparticles can include one or more of titanium oxide (TiO₂), zirconium dioxide (ZrO₂), tantalum oxide (Ta₂O₅), niobium oxide (Nb₂O₅), lanthanum oxide (La₂O₃), bismuth oxide (Bi₂O₃), or zinc oxide (ZnO). In another embodiment, which can be combined with other embodiments described herein, the ink is derived from metal oxide precursors, including but not limited to, metal alkoxides, metal acetates and metal nitrates. Several precursor examples include titanium tetraisopropoxide, zirconium butoxide, zirconium acetate, zirconium acetylacetonate, tantalum ethoxide, zinc nitrate, zinc acetate. The ink formulation may also contain the following components: solvents such as water, ethanol, propylene glycol methyl ether, cyclopentanone; acid and bases such as acetic acid, hydrochloric acid, citric acid, sodium hydroxide, ethanolamine; crosslinkers, monomers and polymers such as triethylene glycol dimethacrylate, 9-vinyl carbazole, polyimides, and polyphosphonates. The inkjet material 108 after curing has an inkjet refractive index of between about 1.6 and about 3.0. The refractive index of the optical device structures 102 is also between about 1.6 and about 3.0.

FIGS. 2A-2C are schematic, top views of a donor substrate 115. Each donor substrate 115 includes a plurality of gratings 104. Each grating 104 includes the plurality of optical device structures 102 (shown in detail in FIG. 1). The plurality of gratings 104A-C are each fabricated on a separate donor substrate 115 to allow dense packing of gratings 104. The plurality of gratings 104 are not limited to a rectangular shape as shown in FIGS. 2A-2C.

FIG. 2A includes a first configuration 200A of the donor substrate 115. The first configuration 200A includes the plurality of first gratings 104A formed on the donor substrate 115. Each of the plurality of first gratings 104A corresponds to an input coupling grating. Each donor substrate 115 may hold between 4 and 3000 first gratings 104A depending on the size of the donor substrate 115. For example, the donor substrate 115 may include about 160 of the first gratings 104A. The plurality of the first gratings 104A may be formed on the donor substrate 115 as needed to maximize the number of the first gratings 104A on the donor substrate 115.

FIG. 2B includes a second configuration 200B of the donor substrate 115. The second configuration 200B includes the plurality of second gratings 104B formed on the donor substrate 115. Each of the plurality of second gratings 104B corresponds to an intermediate grating. Each donor substrate 115 may hold between 4 and 300 second gratings 104B depending on the size of the donor substrate 115. For example, the donor substrate 115 may include about 32 of the second gratings 104B. The plurality of the second gratings 104B may be formed on the donor substrate 115 as needed to increase or maximize the number of the second gratings 104B on the donor substrate 115.

FIG. 2C includes a third configuration 200C of the donor substrate 115. The third configuration 200C includes the plurality of third gratings 104C formed on the donor substrate 115. Each of the plurality of third gratings 104C corresponds to an output grating. Each donor substrate 115 may hold between 4 and 300 third gratings 104C depending on the size of the donor substrate 115. For example, the donor substrate 115 may include about 24 of the third gratings 104C. The plurality of the third gratings 104C may be formed on the donor substrate 115 as needed to maximize the number of the third gratings 104C on the donor substrate 115.

Forming the first gratings 104A, the second gratings 104B, and the third gratings 104C on distinct donor substrates 115 allows for the utilization of more surface area of the donor substrate 115. As described below in method 300, forming the first gratings 104A, the second gratings 104B, and the third gratings 104C on distinct donor substrates 115 will decrease cost of optical device fabrication by utilizing more surface area of the donor substrates 115. Additionally, the fabrication of the first gratings 104A, the second gratings 104B, and the third gratings 104C each may employ different fabrication operations. Thus, fabrication costs may be further reduced by forming the respective gratings separately such that each donor substrate 115 may be subject to the same fabrication process.

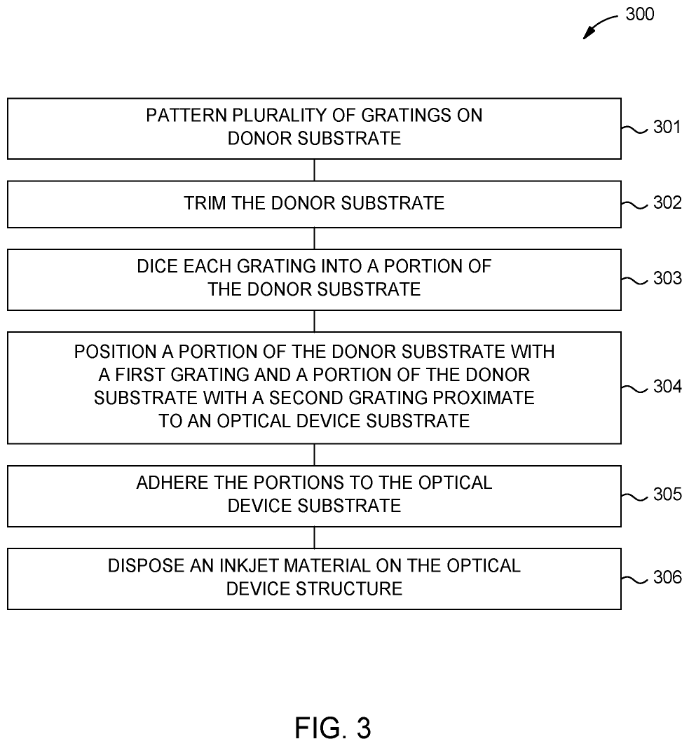

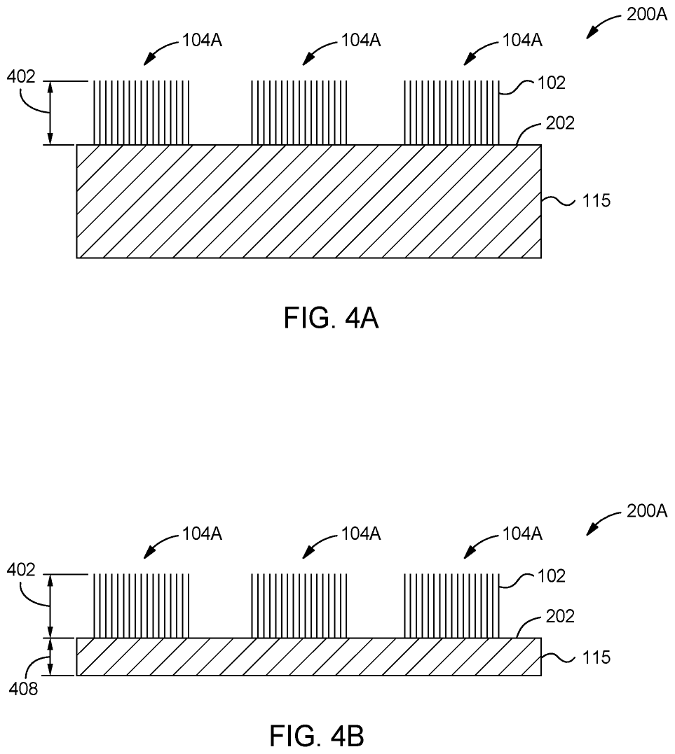

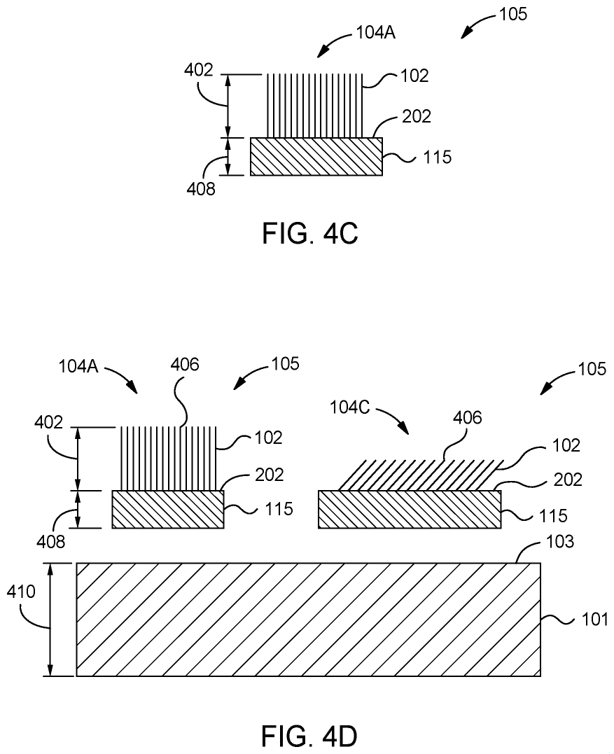

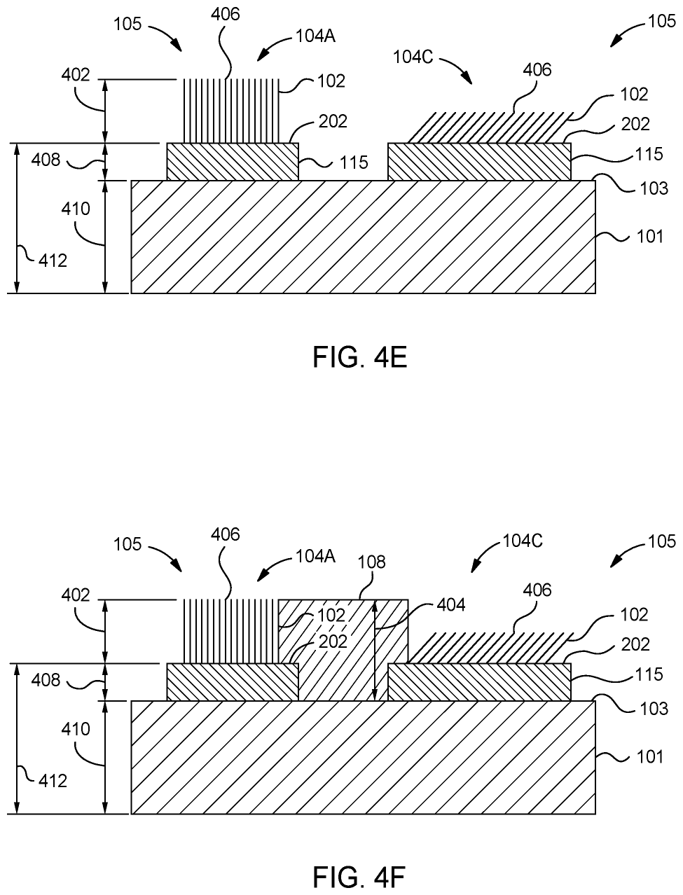

FIG. 3 is a flow diagram of a method 300 of forming the optical device 100 as shown in FIGS. 4A-4F. FIGS. 4A-4F are schematic, side views of the formation of the optical device 100 during the method 300. To facilitate explanation, the method 300 and the FIGS. 4A-4F depict the optical device 100 with the first gratings 104A (e.g., the input coupling grating) and the third gratings 104C (e.g., the output coupling grating), however, the method 300 contemplates the formation of the optical device 100 with the second gratings 104B (e.g., the intermediate grating) as well. Additionally, although the optical device structures 102 of each grating 104 are formed at the same height 402, it is contemplated that the height 402 of each of the optical device structures 102 may vary across the donor substrate 115.

At operation 301, as shown in FIG. 4A, a plurality of gratings 104 are patterned on a donor substrate 115. Although FIG. 4A only shows the first gratings 104A being formed on the donor substrate 115, the second gratings 104B and/or the third gratings 104C are formed on different donor substrates 115. The plurality of gratings 104 of each donor substrate 115 are substantially identical. It is contemplated that the method 300 described herein is not limited to one grating type on one donor substrate 115. It is contemplated to design and fabricate different gratings on the same donor substrate 115 to further utilize the blank area of each respective donor substrate 115. To facilitate explanation, operations 301-303 will be described with reference to the first gratings 104A. However, the operations 301-303 may also be performed with the second gratings 104B and the third gratings 104C. Although only three of the first gratings 104A are shown in FIG. 4A, it is contemplated that any number of the gratings 104 may be formed on the donor substrate 115.

At operation 302, as shown in FIG. 4B, the donor substrate 115 is trimmed. The donor substrate 115 is trimmed to a donor substrate height 408. The donor substrate height 408 is determined based on a predetermined substrate thickness 412 (shown in FIGS. 4E and 4F). The predetermined substrate thickness 412 is the summation of the donor substrate height 408 and an optical device substrate height 410. The donor substrate 115 is trimmed such that when positioned on the optical device substrate 101, the predetermined substrate thickness 412 is achieved. For example, the desired substrate thickness 412 is 800 μm, the optical device substrate height 410 is 500 μm, and thus the donor substrate height 408 would be about 300 μm.

At operation 303, as shown in FIG. 4C, each grating 104 (e.g., each first grating 104A shown in FIG. 4C) is diced into a portion 105 of the donor substrate 115. The portions 105 are diced with a substrate dicing process such as laser ablation cutting, filamentation, diamond blade cutting, or using a precision dicing saw.

At operation 304, as shown in FIG. 4D, the portion 105 of the donor substrate 115 with the first grating 104A and the portion 105 of the donor substrate 115 with the third grating 104C are positioned proximate an optical device substrate 101. In some embodiments, the portion 105 of the donor substrate 115 with the second grating 1048 (not shown) are bonded to the optical device substrate 101. To assist with alignment of the donor substrate 115 and optical device substrate 101, alignment marks are designed and fabricated on the optical device substrate 101 and the donor substrate 115. The alignment marks can be complementary in shape, or the position of each mark can be read by an alignment system to calculate and align the relative positions of the optical device substrate 101 and the donor substrate 115. The plurality of optical device structures 102 of the first grating 104A are perpendicular relative to the surface 202 of the donor substrate 115 and the upper surface 103 of the optical device substrate 101. The plurality of optical device structures 102 of the third grating 104C are angled relative to the surface 202 of the donor substrate 115 and the upper surface 103 of the optical device substrate 101. Each of the gratings 104 may be angled or perpendicular relative to the surface 202.

At operation 305, as shown in FIG. 4E, the portion 105 of the donor substrate 115 with the first grating 104A is adhered to an optical device substrate 101. Further, the portion 105 of the donor substrate 115 with the third grating 104C is adhered to the optical device substrate 101. In some embodiments, the portion 105 of the donor substrate 115 with the second grating 1048 (not shown) are bonded to the optical device substrate 101. The multiple portions 105 of the donor substrate 115 adhere to the optical device substrate by bonding to the portions 105, using a process such as adhesive bonding, glass frit bonding, or fusion bonding. Fusion bonding refers to spontaneous adhesion of two planar substrates without the addition of any intermediate layer. In fusion bonding, a plasma pretreatment can be used to generate a clean surface free from organic contamination.

At operation 306, as shown in FIG. 4F, an inkjet material 108 is disposed on the optical device substrate 101 to form the optical device 100. The inkjet material 108 is disposed to be in between the optical device structures 102 of each grating 104. The inkjet material 108 is also disposed to be between each adjacent donor substrate 115. The inkjet material 108 is disposed via an inkjet printing process. The inkjet material 108 is disposed with an inkjet height 404. The inkjet height 404 is in plane or higher with a top surface 406 of the optical device structures 102.

The inkjet refractive index is substantially equal to a first refractive index of the optical device substrate 101 and a second refractive index of the donor substrate 115. The inkjet material 108 optically interconnects the first grating 104A to the third grating 104C such that the optical path of incident light on the optical device 100 allows for total internal reflection. For example, because the inkjet refractive index is substantially equal to a first refractive index of the optical device substrate 101 and a second refractive index of the donor substrate 115, light is able to propagate through the optical device 100. The inkjet material 108 does not require extra patterning operations to define the area of interconnection between the gratings 104.

In summation, optical device fabrication using methods of discrete grating assembly and optical interconnection are provided herein. In operation, discrete gratings corresponding to one of an input coupling grating, an intermediate grating, or an output coupling grating of an optical device are formed on separated donor substrates. The donor substrates are diced into individual gratings and adhered to an optical device substrate. An inkjet material is disposed between the gratings to optically interconnect the portions of the optical device. By forming each grating on separate substrates, optical device fabrication costs are reduced due to improved use of substrate surface area.

What is claimed is:

1. An optical device, comprising:
an optical device substrate;
a portion of a first donor substrate disposed on an upper surface of the optical device substrate;
a first grating disposed on the portion of the first donor substrate, the first grating including a first plurality of optical device structures;
a portion of a second donor substrate disposed on the upper surface of the optical device substrate;
a second grating disposed on the portion of the second donor substrate, the second grating including a second plurality of optical device structures; and
an inkjet material disposed between the first grating and the second grating, the inkjet material having an inkjet height, wherein the inkjet height is planar with or greater than a height of the first plurality of optical device structures and the second plurality of optical device structures.

2. The optical device of claim 1, wherein the inkjet material has an inkjet refractive index, the optical device substrate has a first refractive index, the first donor substrate has a second refractive index, and the second donor substrate has a third refractive index, wherein the first refractive index, the second refractive index, the third refractive index, and the inkjet refractive index are substantially equal.

3. The optical device of claim 2, wherein the inkjet refractive index is between about 1.6 and about 3.0.

4. The optical device of claim 1, wherein the inkjet material includes colloidal dispersion of nanoparticles or metal oxide precursors.

5. The optical device of claim 1, further comprising:
a portion of a third donor substrate disposed on the upper surface of the optical device substrate; and
a third grating disposed on the portion of the third donor substrate, the third grating including a third plurality of optical device structures, wherein the third grating corresponds to an intermediate grating.

6. The optical device of claim 1, wherein the first grating is an input coupling grating.

7. The optical device of claim 1, wherein the second grating is an output coupling grating.

8. The optical device of claim 1, wherein the inkjet material is operable to optically interconnect the first grating to the second grating to create an optical path for incident light.

9. The optical device of claim 1, wherein:
the first plurality of optical device structures are perpendicular relative to the upper surface of the optical device substrate; and
the second plurality of optical device structures are non-perpendicular relative to the upper surface of the optical device substrate.

10. The optical device of claim 1, wherein the inkjet height is planar with the height of the first plurality of optical device structures and the second plurality of optical device structures.

11. An optical device, comprising:
an optical device substrate, the optical device substrate having a first refractive index;
a portion of a first donor substrate disposed on an upper surface of the optical device substrate, the first donor substrate having a second refractive index;
a first grating disposed on the portion of the first donor substrate, the first grating including a first plurality of optical device structures;
a portion of a second donor substrate disposed on the upper surface of the optical device substrate, the portion of the second donor substrate having a third refractive index;
a second grating disposed on the portion of the second donor substrate, the second grating including a second plurality of optical device structures; and
an inkjet material disposed between the first grating and the second grating, the inkjet material having an inkjet refractive index, wherein the inkjet refractive index, the first refractive index, the second refractive index, and the third refractive index are substantially equal.

12. The optical device of claim 11, wherein the inkjet refractive index is between about 1.6 and about 3.0.

13. The optical device of claim 11, wherein the inkjet material includes colloidal dispersion of nanoparticles or metal oxide precursors.

14. The optical device of claim 11, wherein the first grating is an input coupling grating.

15. The optical device of claim 11, wherein the second grating is an output coupling grating.

16. The optical device of claim 11, wherein the inkjet material is operable to optically interconnect the first grating to the second grating to create an optical path for incident light.

17. A method of forming an optical device, comprising:
forming input coupling gratings on a first donor substrate;
forming output coupling gratings on a second donor substrate;
trimming each of the first donor substrate and the second donor substrate to a donor substrate height;
dicing each input coupling grating and each output coupling grating into a portion of the first donor substrate and a portion of the second donor substrate;
adhering the portion of the first donor substrate and the portion of the second donor substrate to an upper surface of an optical device substrate; and
disposing an inkjet material between the input coupling grating and the output coupling grating on the optical device substrate.

18. The method of forming an optical device of claim 17, wherein the inkjet material optically interconnects the input coupling grating to the output coupling grating to create an optical path for incident light.

19. The method of forming an optical device of claim 17, further comprising disposing the inkjet material directly on the upper surface of the optical device substrate and between the first donor substrate and the second donor substrate.

20. The method of forming an optical device of claim 17, further comprising:
forming intermediate gratings on a third donor substrate;
trimming the third donor substrate to the donor substrate height;
dicing each of the intermediate gratings into a portion of the third donor substrate;
adhering the portion of the third donor substrate to the upper surface of the optical device substrate; and
disposing an inkjet material between the input coupling grating, the output coupling grating, and the intermediate grating on the optical device substrate.
